(19) United States
(12) Patent Application Publication
(10) Pub. No.: US 2004/0196481 A1
(43) Pub. Date: Oct. 7, 2004

(54) Text transformations on a printing device

(76) Inventor: Dana A. Jacobsen, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/409,549

(22) Filed: Apr. 7, 2003

(51) Int. Cl. G06F 17/21; G06K 15/02; G06F 15/00

(52) U.S. Cl. 358/1.11; 382/180; 715/531; 715/533

(57) ABSTRACT

The present disclosure relates to performing text transformations on a printing device. Transformation functions are implemented by program modules written in an interpretative language and executed on the printing device. Advantages of the disclosed system and methods for performing text transformations on a printing device include a reduction in costs associated with producing such devices and an improved capability for extending and upgrading the transformations available on such devices.

### TECHNICAL FIELD

The present disclosure relates to text transformations, and more particularly, to performing text transformations on a printing device.

### BACKGROUND

Documents printed in different computing environments can have a wide range of formatting. For example, a document may have graphics and include text with complex formatting such as various font types, font sizes, tabs, indents, and the like, that is incorporated by a word processor application and translated into an appropriate PDL (page description language) by a printer driver prior to being sent to a printer for printing. On the other hand, a document may simply include text with little or no formatting that is sent directly to a printer without being pre-processed by a printer driver.

Computing environments that employ devices having limited computing resources often involve text documents that contain little or no formatting. Such devices include PDA's (personal digital assistants) such as Hewlett-Packard's Palmtop and 3Com's PalmPilot. A UNIX computing environment is another environment in which text documents having little or no formatting are commonly printed. Much of the work done in a UNIX environment (e.g., source code development) does not include complex formatting. Thus, documents printed in a UNIX environment are often text documents.

Performing text transformations such as spell checking, grammar checking, language translation, keyword highlighting, syntax coloring, and the like, on a printer can be beneficial in various computing environments. However, such transformations may be particularly useful in computing environments such as those described above in which much of the printed output is text that has little or no formatting. Therefore, the ability to perform such transformations on a printing device can provide users with a convenient and consistent way to customize text documents that otherwise may not be available in certain computing environments.

The current method for performing such transformations on a printer involves transformation modules that are hard-coded into firmware on the printer. That is, text transformations are performed by compiled program code that is embedded in ROM (read only memory) on the printer. The code is typically assembly code or “C” code that is specialized to the particular printer. This method of executing text transformations on a printer has a number of disadvantages.

One disadvantage is that the types and numbers of transformations available on a printer are typically permanently set once the code is compiled or the printer is manufactured. Therefore, as new text transformations are developed or existing transformations are improved upon (e.g., updated spell checkers, grammar checkers, language translations), users typically cannot take advantage of them until a new printer model is manufactured. Thus, current printers configured to perform text transformations offer little if any user extensibility or upgradability regarding these transformations.

Another disadvantage with the current method of providing text transformations on a printer is the considerable costs associated with developing such a printer. Printer manufacturers can incur significant costs in time and money developing text transformation program code and installing that program code into the ROM on a printer.

Accordingly, the need exists for a way to provide text transformations on a printer that allows for easy upgradability and extensibility of such transformations by a user, and that reduces the amount of time and money needed to develop printers that include such text transformations.

### SUMMARY

In one embodiment, a printing device is configured to perform various transformations on text input prior to outputting the text onto a print medium. The printing device interprets an instruction that informs the device which transformation function or group of transformation functions should be applied to the text. Each transformation function is implemented by a separate software module stored in memory and programmed in an interpretative language such as Java, Perl, Python, Visual Basic, or C-Sharp.

In one embodiment, a printer employs a text transformation setup module configured to discover text within a print job and interpret transformation instructions. Based on a transformation instruction received locally at the printer front panel, or remotely from a networked computer, the printer configures a series of one or more transformations with which to process the text. The text is extracted from the print job and processed through the transformations before being reinserted back into the print job as transformed text and output onto a print medium.

### BRIEF DESCRIPTION OF THE DRAWINGS

The same reference numbers are used throughout the drawings to reference like components and features.

FIG. 1 illustrates a system environment suitable for performing text transformations on a printing device.

FIG. 2 is a block diagram illustrating in greater detail, an exemplary embodiment of an input device and a printing device that are suitable for implementation in the system environment shown in FIG. 1.

FIG. 3 is a block diagram illustrating in greater detail, an additional exemplary embodiment of an input device and printing device that are suitable for implementation in the system environment of FIG. 1.

FIG. 4 is a flow diagram illustrating an example method of performing text transformations on a printing device such as that shown in the system environment of FIG. 1.

FIG. 5 is a flow diagram illustrating an alternate example method of performing text transformations on a printing device such as that shown in the system environment of FIG. 1.

### DETAILED DESCRIPTION

The present disclosure relates to performing text transformations on a printing device. Transformation functions are implemented by program modules written in an interpretative language (also referred to sometimes as a scripting language) and executed on the printing device. Advantages of the disclosed system and methods for performing text transformations on a printing device include a reduction in costs associated with producing such devices and an improved capability for extending and upgrading the transformations available on such devices.

Exemplary System Environment For Performing Text Transformations On A Printing Device

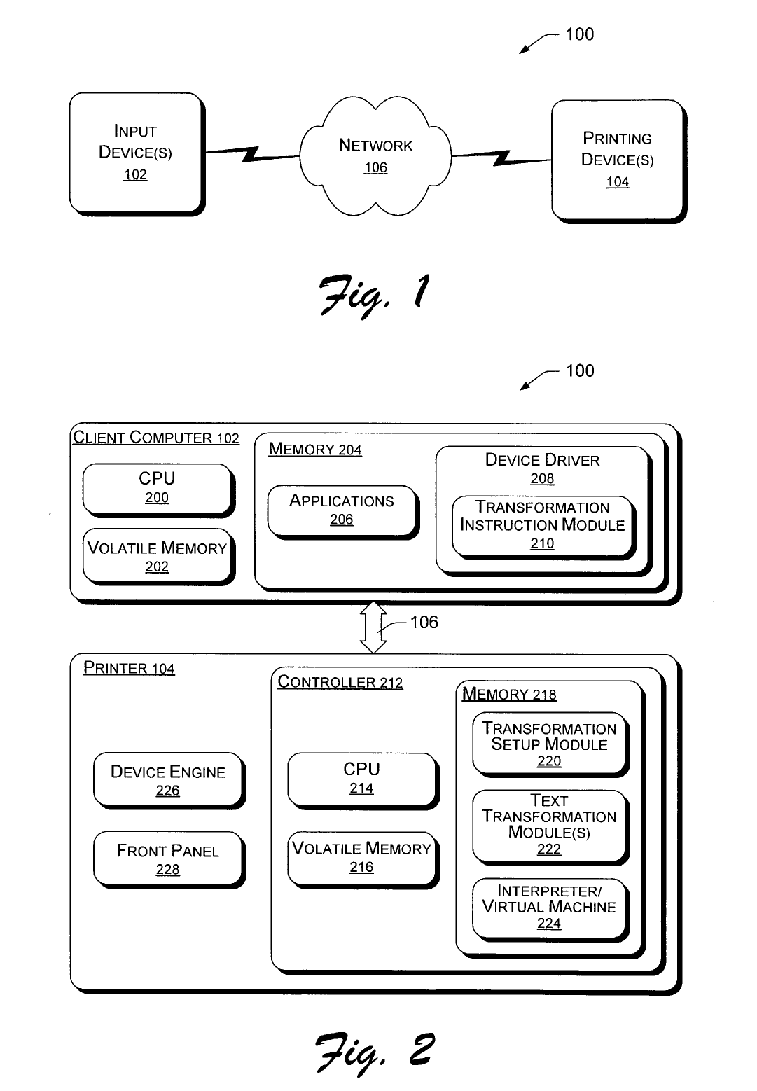

FIG. 1 illustrates an example of a system environment 100 suitable for performing text transformations on a printing device. The system 100 includes input device(s) 102, printing device(s) 104, and a communication network 106 operatively coupling input device(s) 102 to printing device(s) 104. The communication network 106 can include both local and remote connections depending on the particular system configuration. Thus, network connection 106 may include, for example, a printer cable, a LAN (local area network), a WAN (wide area network), an intranet, the Internet, and other such suitable communications links. Network connection 106 can also include wireless communications links such as IR (infrared) or RF (radio frequency) links.

Input device(s) 102 can be implemented as a variety of general purpose computing devices including, for example, a personal computer (PC), a laptop computer, a handheld PDA (e.g., Palmtop, PalmPilot), a Macintosh, a workstation computer, and other devices configured to communicate with printing device(s) 104. An input device 102 typically provides a user with the ability to manipulate or otherwise prepare in electronic form, an image or document to be rendered as an image that is printed or otherwise formed onto a print medium by a printing device 104 after transmission over network 106.

In general, input device 102 outputs formatted and unformatted data to printing device 104 which converts the data and outputs it onto an appropriate recording media, such as paper or transparencies. Unformatted data from input device 102 typically includes simple text data. Formatted data can include text data having complex formatting to implement features such as various font types, font sizes, tabs, indents, and the like. Such formatting is typically incorporated, for example, by a word processor application and then translated by a printer driver into a PDL (page description language) format suitable for printing device 104, such as Hewlett Packard's PCL (Printer Control Language) or Adobe's PostScript prior to being sent to printing device 104. In addition, data from input device 102 can include graphics data and instruction data that contains processing instructions for how printing device 104 is to process data from input device 102.

This disclosure is applicable to various types of printing devices 104 capable of rendering formatted (e.g., PDL) and unformatted data in printed form on a print medium, such as printing pixels on paper. Therefore, printing device(s) 104 can include devices such as laser-based printers, ink-based printers, dot matrix printers, dry medium printers, plotters and the like. In addition, printing device(s) 104 might also include various multi-function peripheral (MFP) devices that combine a printing function with other functions such as facsimile transmission, scanning, copying and the like. Hereinafter, printing device 104 may also be referred to simply as a printer 104 or some variation thereof. These terms are likewise intended to encompass the various types of printing devices 104 just described.

In general, a printer 104 receives input data as a print job transmitted by an input device 102 over network 106. Printer 104 is configured to render the print job as a hard copy image document formed on various print media. Prior to rendering the print job onto print media, printer 104 may also process the print job to effect various outcomes in the printed image. For example, printer 104 may apply one or more text transformations to the textual content of the print job, resulting in transformations in the text, such as the correction of spelling or grammatical errors, a translation into a different language, the highlighting of keywords and the like. Such text transformation processing is discussed in greater detail below.

Exemplary System Embodiment For Performing Text Transformations On A Printing Device

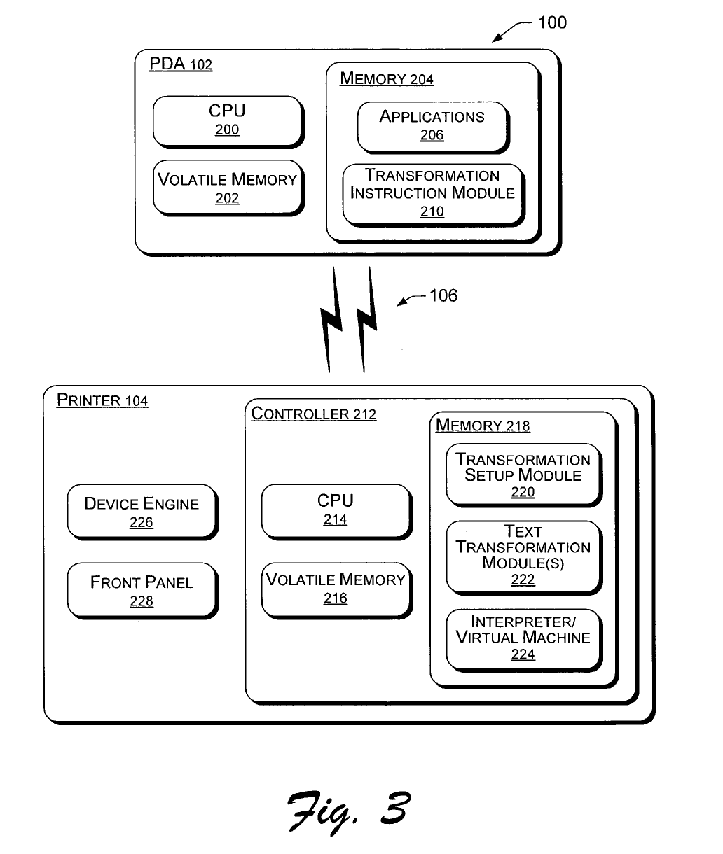

FIG. 2 is a block diagram illustrating in greater detail, an exemplary embodiment of devices suitable for implementation in the system environment 100 of FIG. 1. Input device 102 is embodied as a client computer 102 operatively coupled to printer 104. In general, computer 102 and printer 104 operate to provide a user with the ability to have text transformations performed on printer 104.

Client computer 102 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for client computer 102. Client computer 102 may implement various application programs 206 stored in memory 204 and executed on processor 200 that create or otherwise form a document or image (e.g., text and/or graphics) on a computer screen that is transferable over network connection 106 to printer 104 for creating a hard copy of the document/image. Such applications 206 might include software programs implementing, for example, word processors, spread sheets, browsers, multimedia players, illustrators, computer-aided design tools and the like.

Client computer 102 may also implement one or more software-based device drivers such as printer driver 208 that are stored in nonvolatile memory 204 and executed on processor 200. Device drivers might also be implemented on the specific devices they are “driving” such as printer 104. In general, printer driver 208 formats document information into a page description language (PDL) such as Hewlett Packard's PCL (Printer Control Language) or Adobe's PostScript or another appropriate format which is output to printer 104. In the current embodiment, printer driver 208 additionally includes a transformation instruction module 210 generally configured to communicate a user's preference for text transformations to be performed on printer 104 as discussed more fully herein below.

Printer 104 of the FIG. 2 embodiment includes controller 212 that, in general, processes data from client computer 102 to control the output of printer 104 through printer device engine 226. The controller 212 typically includes a data processing unit or CPU 214, a volatile memory 216 (i.e., RAM), and a nonvolatile memory 218. Nonvolatile memory 218 can include various computer storage media such as ROM, flash memory, a hard disk, a removable floppy disk, a removable optical disk and the like. Nonvolatile memory 218 generally provides storage of computer/processor-readable instructions, data structures, program modules and other data for printer 104.

Accordingly, nonvolatile memory 218 includes text transformation setup module 220 which is generally configured to identify textual content within a print job and to interpret text transformation instructions received either locally through a front panel 228 or remotely from computer 102 or other input device 102. Nonvolatile memory 218 additionally includes one or more text transformation module(s) 222 each configured to perform a transformation function on the textual content prior to the printer 104 outputting the print job through printer device engine 226. Text transformation functions generally include algorithms or processing steps performed to analyze and/or manipulate textual content to bring about a desired effect in the textual content, such as altering font types and sizes, correcting spelling, and so on. Text transformation module(s) 222 can be installed in memory 218 when printer 104 is manufactured. Furthermore, additional and upgraded text transformation module(s) 222 can be received over network 106 and installed in memory 218 at any time. Thus, in addition to performing typical text transformations such as controlling font types, font sizes, tabs, indents, and the like, transformation module(s) 222 can be configured to perform various other arbitrary text transformations. Text transformation module(s) 222 may also reside in volatile memory 216 on a temporary basis.

Text transformation module(s) 222 are programmed in an interpretative language such as Java, Perl, Python, Visual Basic, or C-Sharp. Therefore, nonvolatile memory 218 also includes interpreter/virtual machine 224, configured to execute on processor 214 to interpret and implement text transformation module(s) 222 in an appropriate interpretive language. The execution of such interpretive languages through interpreters/virtual machines is generally well-known in the art. The text transformation process implemented via setup module 220 and transformation module(s) 222 is discussed more fully below.

The nature of interpretative languages such as Java, Perl, Python, Visual Basic, or C-Sharp and their execution via interpreters or virtual machines provides for cost effective development of printers 104 that implement text transformation module(s) 222 programmed in such languages. In addition, printers 104 implementing text transformation module(s) 222 in an interpretive language can be easily updated with new and/or upgraded transformation modules as mentioned above. Users can easily develop and share new and upgraded transformation modules. This provides significant flexibility and advantages to printers 104 that implement transformation module(s) 222 in interpretive languages.

As mentioned above, transformation instruction module 210 is configured to communicate a user's preference for text transformations to be performed on printer 104. Typically, a user initiates printer driver 208 through a print command selected from within an application program 206. Upon initiation, driver 208 configures data from application program 206 into a print job which is sent to printer 104 for rendering. In the FIG. 2 embodiment, the transformation instruction module 210 within driver 208 additionally offers a user options for processing the textual content of a print job on printer 104. The user can therefore select various text transformations to be performed by printer 104 that include, for example, functions such as font types, font sizes, spell checking, grammar checking, language translation, keyword highlighting, syntax coloring, and so on. Such transformation choices are typically presented to a user through selectable tabs within the driver 208 interface presented on the view screen of computer 102. Thus, along with sending a print job to printer 104, driver 108, through transformation instruction module 210, additionally sends an instruction that informs printer 104 which text transformations should be performed on the textual content of the print job.

Text transformation module(s) 222 are executed on printer 104 to implement various transformation functions on textual content received by printer 104. As indicated above, text transformation module(s) 222 are executed in a well-known manner through an interpreter/virtual machine executing on processor 214. Text transformation module(s) 222 can implement various functions to control formatting of text content such as font types, font sizes, spell checking, grammar checking, language translation, keyword highlighting, syntax coloring, and so on. Transformed textual content typically includes transformation indicators inserted by transformation module(s) 222 that specify how the textual content has been transformed and how it is to be displayed when output from printer 104. Transformation indicators may include, for example, data tags inserted at appropriate locations within the textual content that indicate various transformations made to various portions of the textual content. PDL commands are another example of transformation indicators that can be inserted into text content by transformation module(s) 222 to control various text formatting. Such transformation indicators inform controller 212 how to output the transformed textual content through device engine 226.

Transformation setup module 220 is configured to receive print jobs and transformation instructions from computer 102. In the alternative, transformation instructions may be received from the printer 104 front panel 228 or from other input devices 102 not necessarily associated with a print job. Such other input devices 102 might include, for example, a computing device operated by a system administrator tasked with configuring printer 104 to implement predetermined text transformations on all prints jobs processed through printer 104. Setup module 220 interprets and executes a text transformation instruction in order to line up, or “pipeline”, the appropriate text transformation module(s) 222 as specified in the instruction. Thus, a series of one or more text transformations is specified by a transformation instruction for processing textual content from the print job.

Transformation setup module 220 is further configured to parse a print job and locate textual content within the job. Thus, setup module 220 has the intelligence to understand and manipulate print jobs (i.e., input data) having a variety of different formats. For example, a print job from computer 102 may often include document information from an application program 206 that has been formatted by printer driver 208 into a page description language (PDL) such as Hewlett Packard's PCL (Printer Control Language) or Adobe's PostScript. Setup module 220 has the intelligence to understand and manipulate the PDL in order to locate textual content among other formatting information, instruction data, graphics data, and so on that might also be contained in the PDL formatted print job. On the other hand, a print job from computer 102 may include document information that has not been formatted by a driver 208 and, that is made up mostly or entirely of simple text. In any event, setup module 220 identifies the textual content from the print job and forwards the identified text to the “pipelined” text transformation module(s) 222. After the textual content has been processed through the appropriate text transformation module(s) 222, setup module 220 reinserts the transformed text back into the print job which is then output through print engine 226. Reinserting transformed text back into the print job may include copying over the original text with the transformed text, or removing/extracting the original text from the print job and then inserting the transformed text in place of the original text.

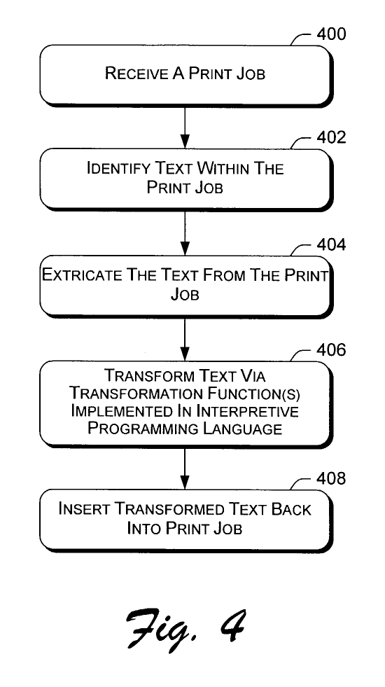

FIG. 3 is a block diagram illustrating in greater detail, an additional exemplary embodiment of an input device and printing device that are suitable for implementation in the system environment 100 of FIG. 1. Input device 102 is embodied as a PDA (personal digital assistant) 102 computing device operatively coupled to printer 104 through a wireless IR (infrared) communication link 106. Like the FIG. 2 embodiment, PDA 102 and printer 104 operate to provide a user with the ability to have text transformations performed on printer 104. The FIG. 3 embodiment is intended to provide an example of a computing environment in which a considerable amount of the input data (i.e., print jobs) received by printer 104 might be simple text input with little or no formatting.

PDA 102 is configured substantially the same as client computer 102 described above with reference to the FIG. 2 embodiment. Thus, PDA 102 includes a processor 200, a volatile memory 202 (i.e., RAM), and a nonvolatile memory 204 (e.g., ROM). Nonvolatile memory 204 generally provides storage of computer/processor-readable instructions, data structures, program modules and other data for PDA 102. However, PDA's in general have limited computing resources when compared with a computer such as the client computer discussed above, for example. This tends to reduce the complexity of the application programs 206 a PDA can implement. Therefore, applications 206 executed by PDA 102 tend to be simpler applications such as calendaring or scheduling applications, or simple text editing applications.

Likewise, PDA 102 is less likely to include a printer driver 208 such as that discussed above with reference to the FIG. 2 embodiment. Thus, the input data or print jobs printer 104 receives from PDA 102 are more likely to be simple text data. Furthermore, although the PDA 102 illustrated in FIG. 3 includes a transformation instruction module 210 configured generally as described above, it is not necessary for PDA 102 to include the transformation instruction module 210. As discussed above with reference to FIG. 2, transformation instructions specifying text transformations to be performed by printer 104 can be received through the printer 104 front panel 228 or from another remote computing device 102. This alleviates the need for transformation instruction module 210 on PDA 102.

In light of the limited formatting capabilities of PDA 102, the FIG. 3 embodiment illustrates an ideal environment for performing text transformations on printer 104. That is, printer 104 can be set to perform various transformations on textual input from PDA 102 that a user desires, but that the PDA 102 itself in incapable of providing. Again, the transformations performed by printer 104 can be set via transformation instructions from PDA 102, front panel 228, or a remote computing device 102.

Printer 104 of FIG. 3 is configured in the same manner as described above with reference to FIG. 2. The main difference is that transformation setup module 220 is less likely to have to parse complexly formatted print jobs in order to locate text and process it through text transformation module(s) 222.

Exemplary Methods For Performing Text Transformations On A Printing Device

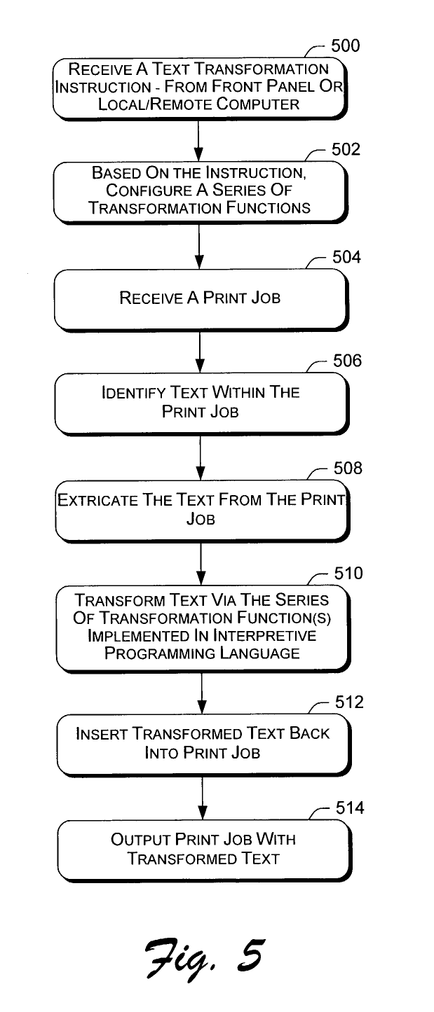

Example methods for performing text transformations on a printing device will now be described with primary reference to FIGS. 4 and 5. The methods apply generally to the exemplary embodiments discussed above with respect to FIGS. 1, 2 and 3. The elements of the described methods may be performed by any appropriate means, such as by the execution of processor-readable instructions defined on processor-readable media, such as a disk, a ROM or other such memory device.

Referring to the method illustrated in FIG. 4, at block 400, a print job is received by a printing device. At block 402, textual content within the print job is identified. At block 404, the textual content identified within the print job is sent to removed or otherwise isolated from the print job and. At block 406, the textual content is transformed by one or more text transformation functions being implemented in an interpretive programming language on the printing device. After the textual content is transformed, it is reinserted back into the print job as shown in block 408.

Referring now to the method illustrated in FIG. 5, at block 500, a text transformation instruction is received by a printing device. The text transformation instruction may be received from the front panel on the printing device, or it may be received from a local or remote computer device coupled to the printing device. At block 502, a series of one or more transformation functions is configured based on the transformation instruction.

At block 504 of FIG. 5, a print job is received by the printing device. At block 506, textual content within the print job is identified. At block 508, the textual content identified within the print job is transferred to the one or more text transformation functions configured in block 502. Transferring the textual content may include removing or otherwise isolating the text from the print job. At block 510, the textual content is transformed by the one or more text transformation functions configured in block 502. The transformation functions are implemented in an interpretive programming language on the printing device.

After the textual content is transformed by the series of text transformation functions, it is reinserted back into the print job at block 512. Reinserting transformed text back into the print job may include copying over (i.e., replacing) the original text with the transformed text, or removing/extracting the original text from the print job and then inserting the transformed text in place of the original text. The print job including the transformed text is then output from the printer at block 514.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
receiving a print job at a printer;
identifying text within the print job; and
transforming the identified text.

2. A processor-readable medium as recited in claim 1, wherein the transforming comprises transforming the identified text through a transformation function.

3. A processor-readable medium as recited in claim 1, wherein the transforming comprises:
transforming the identified text through a transformation function; and
replacing the identified text with transformed text.

4. A processor-readable medium as recited in claim 1, comprising further processor-executable instructions configured for:
receiving a transformation instruction; and
based on the transformation instruction, configuring one or more transformation functions to perform the transforming.

5. A processor-readable medium as recited in claim 4, wherein the receiving a transformation instruction comprises receiving the transformation instruction through a front panel of a printer.

6. A processor-readable medium as recited in claim 4, wherein the receiving a transformation instruction comprises receiving the transformation instruction from a computer device coupled to a printer.

7. A processor-readable medium as recited in claim 1, wherein the transforming includes inserting transformation indicators into the text to control formatting of the text, each transformation indicator indicating a transformation applied to a portion of the text.

8. A processor-readable medium as recited in claim 7, wherein the transformation indicators are selected from a group comprising:
data tags; and
PDL (page description language) commands.

9. A processor-readable medium as recited in claim 1, further comprising processor-executable instructions configured for printing the print job with transformed text.

10. A processor-readable medium as recited in claim 4, wherein each transformation function is implemented by a separate module programmed in an interpretive programming language, the module executable to transform the text in a particular manner.

11. A processor-readable medium as recited in claim 10, wherein the interpretive programming language for each module is a programming language selected from the group of programming languages comprising:
Java;
Perl (Practical Extraction and Reporting Language);
Python;
Visual Basic; and
C-Sharp.

12. A processor-readable medium as recited in claim 1, further comprising processor-executable instructions configured for receiving a user-defined module configured to perform an arbitrary text transformation.

13. A processor-readable medium as recited in claim 2, wherein the transformation function is a function selected from a group of functions comprising:
a spell checking function;
a grammar checking function;
a language translation function;
a keyword highlighting function;
a syntax coloring function
a font type function; and
a font size function.

14. A processor-readable medium comprising processor-executable instructions configured for:
receiving a text-only print job;
processing the text-only print job into a transformed text-only print job through one or more text transformation functions, the transformation functions implemented through an interpretive programming language; and
printing the transformed text-only print job.

15. A processor-readable medium as recited in claim 14, comprising further processor-executable instructions configured for:
receiving a transformation instruction;
based on the transformation instruction, configuring the one or more text transformation functions.

16. A processor-readable medium comprising processor-executable instructions configured for:
receiving a print job;
determining that the print job includes only text;
processing the print job into a transformed print job through one or more text transformation functions implemented as transformation modules programmed in an interpretive programming language; and
printing the transformed print job.

17. A method of transforming text on a printer, comprising:
receiving a print job at a printer;
identifying text within the print job; and
transforming identified text into transformed text through one or more transformation functions, each transformation function implemented by a separate module programmed in an interpretive programming language, the module executable to transform the text in a particular manner.

18. A method as recited in claim 17, wherein the transforming includes replacing the identified text with the transformed text.

19. A method as recited in claim 17, further comprising:
receiving a transformation instruction; and
based on the transformation instruction, configuring the one or more transformation functions.

20. A method as recited in claim 17, wherein the receiving a transformation instruction comprises receiving the transformation instruction through a front panel of a printer.

21. A method as recited in claim 17, wherein the receiving a transformation instruction comprises receiving the transformation instruction from a computer device coupled to a printer.

22. A method as recited in claim 17, wherein the interpretive programming language is a programming language selected from the group of programming languages comprising:
Java;
Perl (Practical Extraction and Reporting Language);
Python;
Visual Basic; and
C-Sharp.

23. A method of transforming text on a printer, comprising:
receiving a text-only print job;
processing the text-only print job into a transformed text-only print job through one or more text transformation functions, the transformation functions implemented through an interpretive programming language; and
printing the transformed text-only print job.

24. A method of transforming text on a printer, comprising:
receiving a print job;
determining that the print job includes only text;
processing the print job into a transformed print job through one or more text transformation functions; and
printing the transformed print job.

25. A printing device, comprising:
a transformation setup module configured to execute a transformation instruction, discover textual content within a print job, and forward the textual content to a transformation block; and
the transformation block, comprising one or more transformation modules configured according to the transformation instruction, each transformation module configured to perform a transformation function on the textual content, and each transformation module being programmed in an interpretive programming language.

26. A printing device as recited in claim 25, wherein the interpretive programming language is a programming language selected from the group of programming languages comprising:
Java;
Perl (Practical Extraction and Reporting Language);
Python;
Visual Basic; and
C-Sharp.

27. A printing device as recited in claim 25, further comprising an interpreter configured to interpret the interpretive programming language.

28. A printing device as recited in claim 25, wherein the transformation setup module is configured to receive transformed textual content from the transformation block and replace the textual content in the print job with the transformed textual content.

29. A printing device as recited in claim 25, further comprising a print engine configured to receive transformed textual content and output the transformed textual content onto a print medium.

30. A printer comprising:
a print job;
a transformation setup module configured to distinguish text within the print job; and
a series of transformation modules written in an interpretive programming language and configured to perform transformation functions on the text.

31. A printer as recited in claim 30, further comprising:
a print engine; and
a controller configured to control the print engine for printing the print job as a printed document, the printed document comprising the text in a transformed state.

32. A system for transforming text on a printing device comprising:
an input device to provide a document; and
a printing device to distinguish text from within the document, transform the text into transformed text through one or more text transformation functions, and form an image of the document on a print medium, the image comprising the transformed text.
